(19) United States
(12) Patent Application Publication
(10) Pub. No.: US 2023/0243071 A1
(43) Pub. Date: Aug. 3, 2023

(54) COMPOSITION FOR ECO-FRIENDLY FILAMENT USING SOYBEAN HULL AND 3D PRINTING ECO-FRIENDLY FILAMENT MANUFACTURED BY USING SAME

(71) Applicant: Andong National University Industry-Academic Cooperation Foundation, Andong-si (KR)

(72) Inventor: Hui Yun HWANG, Seoul (KR)

(73) Assignee: Andong National University Industry-Academic Cooperation Foundation, Andong-si (KR)

(21) Appl. No.: 18/163,841

(22) Filed: Feb. 2, 2023

(30) Foreign Application Priority Data
Feb. 3, 2022 (KR) 10-2022-0014002

(51) Int. Cl. D01F 8/14; B33Y 70/10; B29C 64/118

(52) U.S. Cl. CPC D01F 8/14; B29C 64/118; B33Y 70/10; B29K 2067/046

(57) ABSTRACT

Proposed are a composition for an eco-friendly filament using soybean hulls and a 3D printing eco-friendly filament manufactured by using the same. A manufacturing method of the 3D printing eco-friendly filament by using soybean hulls includes a first step of manufacturing soybean hull powder by grinding the soybean hulls, a second step of manufacturing a composition for an eco-friendly filament by adding biodegradable plastic resin to the soybean hull powder and mixing the biodegradable plastic resin with the soybean hull powder, and a third step of manufacturing the 3D printing eco-friendly filament by cooling the composition for an eco-friendly filament after extruding the composition for an eco-friendly filament through an extruder for filament formation. The composition for a safe and eco-friendly filament while discarded soybean hulls are used for resource utilization and the 3D printing eco-friendly filament manufactured by using the same are provided.

### CROSS REFERENCE TO RELATED APPLICATION

The present application claims priority to Korean Patent Application No. 10-2022-0014002, filed Feb. 03, 2022, the entire contents of which are incorporated herein for all purposes by this reference.

### BACKGROUND OF THE INVENTION

### Field of the Invention

The present disclosure relates generally to a composition for an eco-friendly filament using soybean hulls and a 3D printing eco-friendly filament manufactured by using the same. More particularly, the present disclosure relates to a method of manufacturing an eco-friendly filament by using soybean hulls which are harmless to the human body and are recyclable.

### Description of the Related Art

A 3D (3-Dimension) printer is an apparatus that produces three-dimensional shapes by sequentially spraying ink of a special material and having the ink stacked up in layers with fine thickness. This 3D printing is being used in various fields.

For example, the 3D printing is used by many manufacturers for making various models, such as medical human body models and household products such as toothbrushes and razors, in addition to the field of automobiles composed of many parts.

Currently, a solid thermoplastic which is a material widely used in 3D printing and is free to melt and harden occupies 40% of the market. A thermoplastic material may have the shape of a filament, particle, or powder, and a 3D printer of a filament type among the shapes is faster than a printer of other types in terms of speed and thus is high in productivity, so the 3D printer of a filament type is rapidly spreading.

Existing filament materials include polylactic acid (PLA), acrylonitrile butadiene styrene (ABS), high density polyethylene (HDPE), polycarbonate (PC), nylon, urethane, and PEI, etc., and the reason for this is as follows.

First, each of the materials has a moderately high melting point and is high in solidification speed after being printed, and does not deform even when printing speed is high, thereby having high stability in dimension and shape.

Second, the material has a moderately low melting point and is easy to be extruded when manufacturing a filament, thereby having high production efficiency. Furthermore, when a material has an excessively high melting point, it consumes a lot of power to melt a filament made of the material, and parts in a printer are required to be made of materials that can withstand high heat, which causes an undesirable cost increase.

However, PLA is difficult to work with because PLA makes a printer sticky when melted. Although PLA is an eco-friendly material that is biodegradable, the PLA is difficult to be recycled, and requires attention in material storage because PLA is brittle and has high moisture absorption. In addition, ABS has a bad odor when it is melted, so there is a problem in that the additional work of removing the odor such as ventilating or by leaving the ABS unattended for a long time after printing the ABS is required.

Accordingly, several studies have been conducted on a filament manufacturing process in which natural materials that are eco-friendly materials and add ease of work are used.

In other words, Korean Patent No. 10-1550364 discloses “BIOPLASTIC USING BIOMASS SUCH AS COFFEE BY-PRODUCT AND MANUFACTURING METHOD OF SAME”. However, these natural by-products are unsuitable for manufacturing and using filament, which is a material for 3D printers since the natural by-products clog an extruder for filament formation or deteriorate the quality of a manufactured filament. Accordingly, it is necessary to provide a filament composition composed of a specific eco-friendly by-product that can be used as a filament material without causing the above problems, but an alternative to this is still insufficient.

### Documents of Related Art

(Patent Document 1) Korean Patent No. 10-1813402 “POLYLACTIC ACID LOESS COMPOSITION FOR THREE-DIMENSIONAL PRINTER FILAMENT HAVING EXCELLENT HEAT RESISTANCE AND MECHANICAL PROPERTIES”
(Patent Document 2) Korean Patent No. 10-1771588 “ECO-FRIENDLY FILAMENT USING BIOMASS AND METHOD OF PRODUCING SAME”

### SUMMARY OF THE INVENTION

Accordingly, the present disclosure has been made keeping in mind the above problems occurring in the related art, and the present disclosure is intended to propose a composition for a safe and eco-friendly filament while discarded soybean hulls are used for resource utilization and a 3D printing eco-friendly filament manufactured by using the same.

Technical objectives to be achieved by the present disclosure are not limited to the technical objectives mentioned above, and other technical objectives not mentioned can be clearly understood by those skilled in the art from the description below.

In order to achieve the above objectives, according to one aspect of the present disclosure, there is provided a composition for an eco-friendly filament, the composition including: soybean hulls and a biodegradable plastic resin.

In addition, the biodegradable plastic resin may include at least one of polylactic acid (PLA), polyhydroxyalkanoate (PHA), polybutylene succinate (PBS), polybutylene adipate terephthalate (PBAT), polyethylene (PE), and polypropylene (PP).

Furthermore, a weight ratio of the soybean hulls to the biodegradable plastic resin may be 1 : 1 to 5.

According to another aspect of the present disclosure, there is provided a manufacturing method of a 3D printing eco-friendly filament, the method including: a first step of manufacturing soybean hull powder by grinding the soybean hulls; a second step of manufacturing the composition for an eco-friendly filament by adding the biodegradable plastic resin to the soybean hull powder and mixing the biodegradable plastic resin with the soybean hull powder; and a third step of manufacturing a 3D printing eco-friendly filament by cooling the composition for an eco-friendly filament after extruding the composition for an eco-friendly filament through an extruder for filament formation.

According to the present disclosure, when an eco-friendly filament is made by using soybean hulls, it is possible to increase the income of a farmer in terms of recycling discarded resources.

In addition, by using organic soybean hulls as a material, it is possible to provide a functional filament that is harmless to the human body and relatively inexpensive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objectives, features, and other advantages of the present disclosure will be more clearly understood from the following detailed description when taken in conjunction with the accompanying drawing, in which:

FIG. 1 is a diagram illustrating a manufacturing method of a 3D printing eco-friendly filament step by step according to embodiment 1 of the present disclosure.

### DETAILED DESCRIPTION OF THE INVENTION

Hereinafter, an exemplary embodiment of the present disclosure will be described in detail with reference to the accompanying drawing, and detailed descriptions of well-known functions and configurations that may unnecessarily obscure the subject matter of the present disclosure will be omitted.

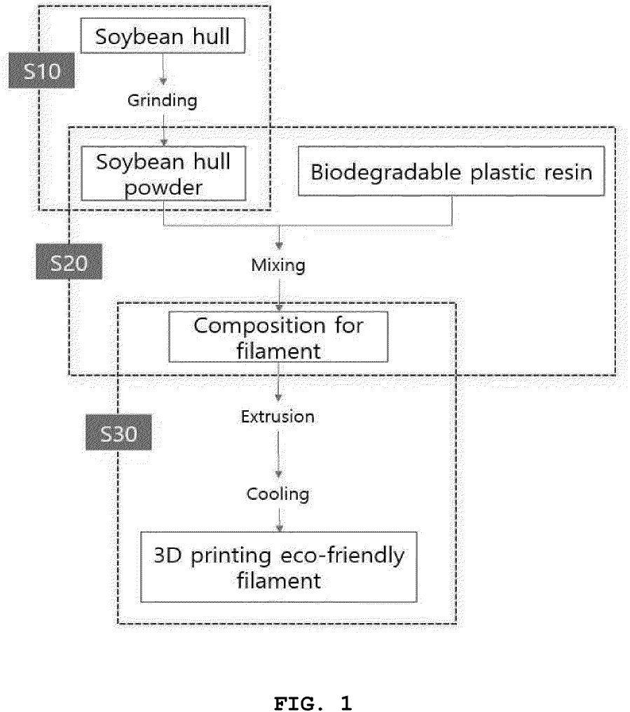

Hereinafter, a manufacturing method of a 3D printing eco-friendly filament of the present disclosure will be described in detail (see FIG. 1).

### A First Step; Manufacturing Soybean Hull Powder at S10

In this step, soybean hulls are ground to manufacture soybean hull powder.

To explain, recently, filament processing is performed so that a filament has an appearance and mechanical properties by mixing wood and carbon materials with a plastic filament that is harmless to the human body, such as PLA, PE, and PP. The wood or carbon materials have the disadvantage of being difficult to decompose.

In addition, although the biodegradable plastic material is a material that is decomposed in nature, decomposition rate thereof is very slow and a cost thereof is economically high. Particularly, PLA is difficult to work with because the PLA makes a printer sticky when melted. Although PLA is an eco-friendly material that is naturally decomposed, the PLA is difficult to be recycled, and has the disadvantage that attention in material storage is required because the PLA is brittle and has high moisture absorption.

Accordingly, while inventors of the present invention are seeking various ways to develop new ways to utilize soybean hulls which are coverings of soybeans that are discarded or used only as livestock feed, the inventors found that the soybean hulls are useful for filament manufacturing.

In other words, a soybean hull contains a large amount of protein components, and thus can improve the appearance and mechanical properties of a filament together with wood or carbon materials.

However, when the soybean hulls are used as they are, the soybean hulls are difficult to be molded into a filament or clog the nozzle of a 3D printer. Accordingly, the soybean hulls are required to be ground to produce soybean hull powder, and in this case, the particle size of the soybean hull powder is 10 to 300 µm.

It is because when the particle size exceeds 300 µm, the mixing of a composition for a filament to be described below is not easy, making the manufacturing of a filament somewhat difficult, and the nozzle of the 3D printer is clogged, making it difficult for the soybean hulls to be used for the 3D printer. Further, it is because making soybean hull powder having a particle size smaller than 10 µm is complicated in a process, which increases a unit price of a filament, thereby making it difficult to manufacture the filament.

### 2. A Second Step; Manufacturing a Composition for an Eco-Friendly Filament at S20

In this step, a biodegradable plastic resin is added to and mixed with the soybean hull powder to manufacture a composition for a filament.

To explain, recently, as a filament material, an eco-friendly plastic resin has been applied, and more preferably, at least one of polylactic acid (PLA), polyhydroxyalkanoate (PHA), poly butylene succinate (PBS), polybutylene adipate terephthalate (PBAT), polyethylene (PE), and polypropylene (PP) is used.

However, although the eco-friendly plastic resin has the advantage of being biodegradable, the eco-friendly plastic resin has stickiness generated by strong heat generated during filament processing, thereby reducing ease of use. Furthermore, the eco-friendly plastic resin is expensive and thus the molding of a filament by using only the biodegradable plastic resin is difficult.

Accordingly, in the present disclosure, soybean hull powder, with which the strength of a filament can be adjusted, and a biodegradable plastic resin used in an existing filament are used in combination with each other. In this case, it is best to mix soybean hulls and the biodegradable plastic resin with each other in a weight ratio of the soybean hulls to the biodegradable plastic resin which is 1: 1 to 5. This is because when the biodegradable plastic resin is contained in less than 1 weight relative to 1 weight of the soybean hulls, it is difficult to form a filament, and when the biodegradable plastic resin is contained in more than 5 weight relative to 1 weight of the soybean hulls, usability of a filament is decreased due to the excessive amount of the biodegradable plastic resin.

In such a composition, each raw material is put into a highspeed mixer and mixed twice for two to five minutes at a speed of 1000 to 1200 RPM so that each material is evenly dispersed so that the filament is properly formed.

### 3. A Third Step; Manufacturing of the 3D Printing Eco-Friendly Filament at S30

In this step, after the composition for an eco-friendly filament is extruded through an extruder for filament formation, the composition for an eco-friendly filament is cooled to manufacture a 3D printing eco-friendly filament.

To explain, when the composition for an eco-friendly filament is molded into a filament, the extruder for filament formation is used. During filament extrusion, the temperature of a screw is 100° C. or less, and later the temperature of the screw and die is preset to 150 to 190° C. for extrusion. Even at this time, it is important to perform the extrusion so that the temperature of each of the screw and die does not exceed 200° C., and a filament that passes through the die is cooled through primary cooling water (50 to 60° C.) and secondary cooling water (30° C. or less).

In this case, the reason why the temperatures of the primary cooling water and the secondary cooling water are different from each other is to allow the circular center portion of the extruded filament to maintain a circular shape in a section in which the filament passes through the primary cooling water, and is to allow the filament to be completely cooled at a low temperature in a section in which the filament passes through the secondary cooling water so that the circular center portion of the extruded filament is prevented from being damaged while the extruded filament is pressed in a tractor zone after the extruded filament passes through a laser sensor that measures the thickness of the extruded filament after going through a moisture removal process.

The filament extruded through this process is wound around a bobbin in a predetermined quantity. At this time, the thickness (mm) and quantity (g) of the filament produced may be determined according to the needs of the consumer.

In addition, before the composition for an eco-friendly filament passes through the extruder for filament formation, the composition for an eco-friendly filament may be first melted through a twin screw extruder to produce small pellets and then the pellets may be processed into a filament through the extruder for filament formation.

In this case, a reason why the twin screw extruder is used is that the twin screw extruder enables the composition to be uniformly dispersed and can perform the work of forming a filament at the melting temperature of 150 to 190° C.

A temperature inside the twin screw extruder is in the range of 150~190° C., so that a biodegradable plastic resin can be melted and uniformly dispersed together with the soybean hull powder. When a temperature inside the twin screw extruder is 200° C. or more, it may cause thermal decomposition of the biodegradable plastic resin and weaken the physical properties of a final product, so it is preferable that the temperature is avoided. Accordingly, the biodegradable plastic resin passing through the twin screw extruder is cooled by passing through water at a room temperature (30~35° C.), is formed into small particles through a pelletizer, and is introduced into a dehumidifying dryer to be dried for about four to eight hours at 70~90° C. so that the moisture content of the raw material can be adjusted to 400 PPM or less. In this case, the reason for dehumidifying and drying the raw material through the dehumidifying dryer is to prevent the biodegradable plastic resin from being destroyed by moisture when the raw material contains a large amount of moisture and is put into the extruder for filament formation to produce a final filament.

Filaments manufactured in this way may be used for various purposes and may have predetermined physical properties. In a 3D printer that melts down the manufactured filaments through a small nozzle by applying heat to the filaments and laminates the filaments, the filaments are output without problems without clogging the nozzle. Accordingly, according to the present disclosure, a 3D printing filament can be provided.

Hereinafter, referring to FIG. 1, the embodiment of the present disclosure will be described in more detail, but is only for illustrative purposes and is not intended to limit the protection scope of the present disclosure.

### <Embodiment 1> the Manufacturing of the 3D Printing Eco-Friendly Filament of the Present Disclosure (FIG. 1)

After obtaining soybean hulls from a market, soybean hull powder having a particle size of 100 µm is manufactured through a grinder.

Next, the composition for an eco-friendly filament is manufactured by adding 2 kg of a PLA biodegradable plastic resin to 1 kg of the soybean hull powder and mixing the PLA biodegradable plastic resin with the soybean hull powder.

Next, a filament having thickness of 1.75 mm is produced by extruding the composition for an eco-friendly filament through the extruder for filament formation, and is cooled through primary cooling water of 50° C. and secondary cooling water of 30° C. to output a 3D printing eco-friendly filament as a specimen.

As described above, it can be seen that a 3D printing eco-friendly filament which does not cause nozzle clogging can be provided by manufacturing a composition for an eco-friendly filament by using discarded soybean hulls according to the manufacturing method of the present disclosure.

The present disclosure has been described with a focus on the exemplary embodiment, and those skilled in the art may implement embodiments different from the detailed description of the present disclosure within the essential technical scope of the present disclosure. Here, the essential technical scope of the present disclosure is indicated in the claims, and all differences within the equivalent range should be construed as being included in the present invention.

What is claimed is:

1. A composition for an eco-friendly filament, the composition comprising:
soybean hulls and a biodegradable plastic resin.

2. The composition of claim 1, wherein the biodegradable plastic resin comprises at least one of polylactic acid (PLA), polyhydroxyalkanoate (PHA), polybutylene succinate (PBS), polybutylene adipate terephthalate (PBAT), polyethylene (PE), and polypropylene (PP) .

3. The composition of claim 1, wherein a weight ratio of the soybean hulls to the biodegradable plastic resin is 1 : 1 to 5.

4. A manufacturing method of a 3D printing eco-friendly filament, the method comprising:
a first step of manufacturing soybean hull powder by grinding soybean hulls;
a second step of manufacturing a composition for an eco-friendly filament by adding a biodegradable plastic resin to the soybean hull powder and mixing the biodegradable plastic resin with the soybean hull powder; and
a third step of manufacturing a 3D printing eco-friendly filament by cooling the composition for an eco-friendly filament after extruding the composition for an eco-friendly filament through an extruder for filament formation.

5. The method of claim 4, wherein during the manufacturing of the composition at the second step, a weight ratio of the soybean hull powder to the biodegradable plastic resin is 1 : 1 to 5.

6. A 3D printing eco-friendly filament manufactured by the method of claim 4.

7. A 3D printing eco-friendly filament manufactured by the method of claim 5.
